(19) United States
(12) Patent Application Publication
(10) Pub. No.: US 2020/0175354 A1
(43) Pub. Date: Jun. 4, 2020

(54) TIME AND ACCURACY ESTIMATE-BASED SELECTION OF MACHINE-LEARNING PREDICTIVE MODELS

(71) Applicant: Deep Learn, Inc., Santa Cruz, CA (US)

(72) Inventors: Stanislav Volodarskiy, St. Petersburg (RU); Vladislav Khizanov, Kiev (UA); Alexander Fishkov, St. Petersburg (RU); Adam Blum, Santa Cruz, CA (US); Dennis Korotyaev, Archangelsk (RU)

(21) Appl. No.: 16/696,919

(22) Filed: Nov. 26, 2019

Related U.S. Application Data
(60) Provisional application No. 62/774,699, filed on Dec. 3, 2018.

(51) Int. Cl. G06N 3/04; G06N 3/08; G06N 20/00

(52) U.S. Cl. CPC G06N 3/0454; G06N 20/00; G06N 3/08

(57) ABSTRACT

Time-based and accuracy-estimate-based trial selection for selection of subsequent machine-learning models in automated machine learning. In an embodiment, a batch of trials are generated for a plurality of machine-learning algorithms. During execution of the trials, a training time is estimated for at least a portion of the models represented in the batch of trials, and a subset of models are selected for evaluation based, at least in part, on their estimated training times. A graphical user interface is updated to reflect the evaluation results of the subset of models, even before the evaluation results for other models become available.

### CROSS-REFERENCE TO RELATED APPLICATIONS

The present application claims priority to U.S. Provisional Patent App. No. 62/774,699, filed on Dec. 3, 2018, which is hereby incorporated herein by reference as if set forth in full.

### BACKGROUND

Field of the Invention

The embodiments described herein are generally directed to automated machine learning, and, more particularly, to optimally selecting which machine-learning models to train to provide the best accuracy within a given timeframe.

Description of the Related Art

Automated machine learning (AutoML) is one of the most robust areas of innovation in applied machine learning. AutoML tools try many different machine-learning algorithms and many values for those algorithms' hyperparameters (i.e., options for the algorithms), in an attempt to find the model with the highest possible predictive accuracy. Even experienced data scientists may require weeks of effort to identify the optimal model.

New AutoML tools are rapidly appearing, from the likes of Google™ and Microsoft™, as well as new startups. The activity in this space promises to make machine learning accessible to the masses, without the need for trained data scientists. However, most AutoML tools still use a naïve approach of trying all algorithms and hyperparameter values until a good predictive model is found.

### SUMMARY

Accordingly, systems, methods, and non-transitory computer-readable media are disclosed for using both time estimation and/or accuracy estimation to find more accurate models in bounded time frames. Specifically, a search algorithm is disclosed which yields better predictive models from the algorithm-hyperparameter space in bounded time frames. The approach results in better predictive models at the end of a set amount of algorithm training and exploration time. It also results in better interim predictive models being presented during the course of training.

In an embodiment, a method is disclosed that comprises using at least one hardware processor to: select a plurality of machine-learning algorithms; generate a batch of trials from the plurality of machine-learning algorithms; begin executing at least a portion of the batch of trials; and, during execution of the batch of trials, provide intermediate evaluation results by, in each of one or more iterations, estimating a training time and model accuracy for two or more of models represented in the batch of trials, selecting at least one of the two or more models with a highest estimated model accuracy and an estimated training time within a predefined training time, evaluating the at least one model before evaluating any other ones of the two or more models, and updating a graphical user interface to provide the evaluation results for the subset of models. The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram that illustrates an example infrastructure, in which one or more of the processes described herein, may be implemented, according to an embodiment;

FIG. 2 is a block diagram that illustrates an example processing system, by which one or more of the processed described herein, may be executed, according to an embodiment;

FIG. 3 is a flowchart that illustrates a process for automated machine-learning management, according to an embodiment;

FIG. 4A is a block diagram that illustrates a process for time and accuracy estimation-based trial selection, according to an embodiment;

FIG. 4B is a block diagram that illustrates an example data flow within the process of FIG. 4A, according to an embodiment; and

FIG. 5 is a block diagram that illustrates an example data flow for configuring an estimation service, according to an embodiment.

### DETAILED DESCRIPTION

In an embodiment, systems, methods, and non-transitory computer-readable media are disclosed for decreasing the time before evaluation results become available to users of a platform for selecting an appropriate machine-learning algorithm. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

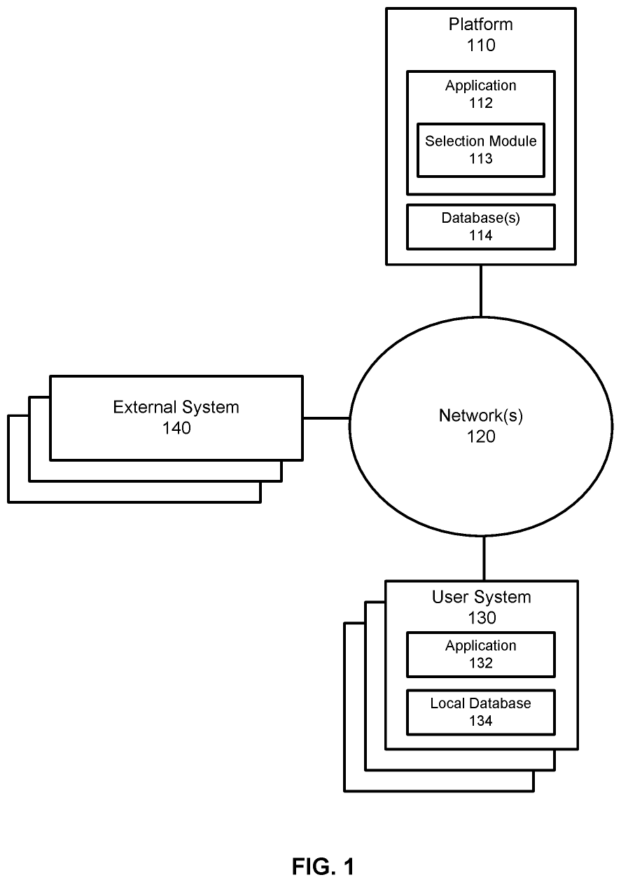

FIG. 1 illustrates an example infrastructure for selecting algorithms for automated machine learning, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application is a browser application, which simply requests, receives, and renders webpages at user system(s) 130, while the server application on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the functions, processes, or methods of the application described herein.

In an embodiment, the application implements a selection module 113 for selecting one or more appropriate machine-learning algorithms. Selection module 113 may be offered as part of a larger service implemented by the application. For example, in an embodiment, the application implements an automated machine-learning service which enables a user to manage the user's machine-learning algorithms, for example, within the user's cloud services. As part of this management, the application may enable a user to select one or more algorithms, optimize hyperparameters for the algorithm(s), and deploy the selected algorithm(s) with the optimized hyperparameters to the user's cloud services. The combination of the algorithm(s) and associated hyperparameters will be referred to herein as a “model.”

Selection module 113 is able to offer a plurality of available algorithms for selection. These available algorithms may comprise basic regression and/or classification algorithms, including, without limitation, logistic regression, linear regression, polynomial regression, k-nearest neighbor, and/or random forest algorithms. The available algorithms may also comprise more complex algorithms, such as deep-learning algorithms or deep neural networks. In addition, selection module 113 may enable users to set appropriate hyperparameters for the training process, and allows users to combine a plurality of algorithms into an ensemble algorithm.

1.2. Example Processing Device

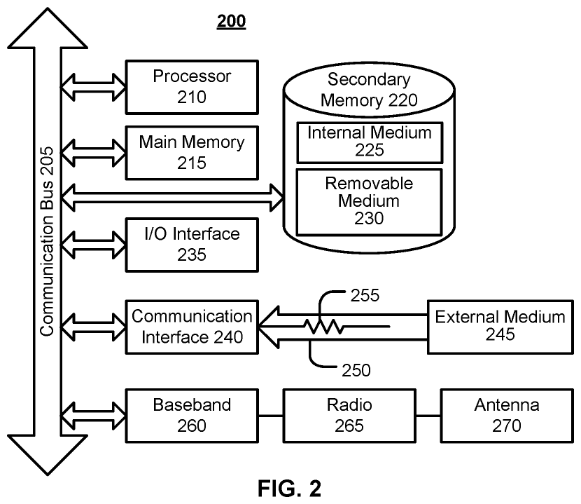

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

2. Process Overview

Embodiments of processes for decreasing the time before evaluation results become available to users of platform 110 will now be described in detail. It should be understood that the described processes may be embodied in one or more software modules that are executed by one or more hardware processors (e.g., processor 210), e.g., as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

An underappreciated aspect of AutoML is that trying all possible algorithms and their hyperparameter values is an infinite time problem. Because of this infinite time problem, all AutoML tools and well-known academic algorithms constrain the time for algorithm selection and training. However, these AutoML tools do not formulate the problem as selecting the best algorithm based on the time constraint. Thus, in an embodiment, a method is disclosed that comprises using at least one hardware processor to select a plurality of machine-learning algorithms, generate a batch of trials from the plurality of machine-learning algorithms, begin executing at least a portion of the batch of trials, and, during execution of the batch of trials, provide intermediate evaluation results. It may involve estimating a training time and accuracy for two or more models represented in the batch of trials, and then selecting the best algorithm and hyperparameter settings to train from an available set of algorithm/hyperparameter setting combinations based on a time constraint set by the user. The method may use both an estimate of the training time for each algorithm and an estimated accuracy of the algorithm and settings to make the selection. For example, the method may use a combination of the estimated training time and the a priori (pre-training) estimated accuracy of the algorithm to choose the next best algorithm to train.

2.1. Automated Machine-Learning Management

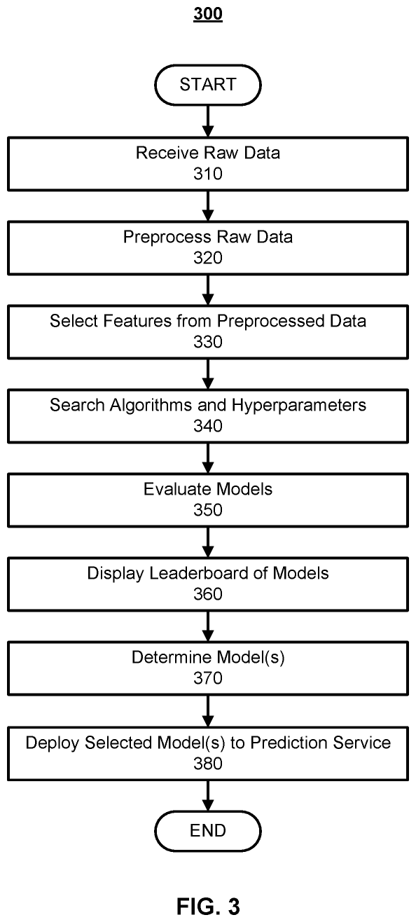

FIG. 3 is a flowchart that illustrates a process 300 for automated machine-learning management, according to an embodiment. While process 300 is illustrated with a certain arrangement and ordering of steps, process 300 may be implemented with fewer, more, or different steps and a different arrangement and/or ordering of steps. In addition, while process 300 is illustrated as a linear process, certain steps may be performed non-linearly (e.g., in parallel) and/or within iterative loops. Process 300 may be implemented by the disclosed application, and, in an embodiment, specifically by server application 112.

In step 310, the application receives raw data. For example, the raw data may be received from a user via a graphical user interface. Specifically, the user may utilize one or more inputs to upload the raw data (e.g., by selecting a file from a file system of the user's user system 130) or otherwise retrieve the raw data (e.g., from database(s) 114, from an external system 140, etc.). The raw data may be received in various formats, including in an electronic document, such as a file of comma-separated values (CSV), a spreadsheet file (e.g., Excel™), and/or the like.

In step 320, the application preprocesses the raw data received in step 310. For example, the raw data may be parsed into a dataset to be used in subsequent steps. Using a CSV file as an example, a data structure may be created for each row of comma-separated values, and each row-specific data structure may comprise field-specific data structures representing each of the comma-separated values in that row. It should be understood that each row should include the same set of fields, although values may not be provided for all fields in a given row. Field names may be included in a header row, which can also be parsed in step 310. All of the row-specific data structures and the field names may be comprised in an overarching data structure representing the entire dataset. Alternatively, the raw data may be maintained in the native file format and re-parsed every time it is needed. In addition to parsing the data, other preprocessing may be performed, such as validating the raw data (e.g., ensuring that it is properly formatted, identifying issues with field values, etc.) and/or the like.

In step 330, the application determines the features to be used by the machine-learning algorithms and/or the target feature to be predicted by the machine-learning algorithms. For example, the application may generate one or more screens of the graphical user interface to include a list of all of the field names identified in the raw data. Each field name may be associated with one or more inputs, including, without limitation, inputs for selecting a data type (e.g., integer, categorical, etc.) to be used for the field, specifying a filter to be used for the values in the field, specifying a default value to be used for missing values in the field, selecting the field as a feature to be used in each machine-learning algorithm, selecting the field as a target feature to be predicted by each machine-learning algorithm, viewing actual values of the field in the dataset, and/or the like. Each field name may also be associated with other information to aid a user in the feature selection process, including, without limitation, a feature correlation, the number of unique values for the field, a range of values for the field, a number of missing values for the field, and/or the like. Using the inputs in the graphical user interface, a user may select one or more target features to be predicted by the machine-learning algorithm and one or more features (e.g., potentially all of the features) to be used by the machine-learning algorithm to predict the target feature(s). The screen(s) of the graphical user interface may also comprise one or more inputs to select a type of machine-learning algorithm to be used (e.g., regression or classification) and initiate the automated evaluation of a plurality of available machine-learning algorithms of the selected type.

In step 340, once the evaluation has been initiated, the application selects at least a subset of available machine-learning algorithms based on one or more user-specified inputs (e.g., the selection of regression or classification as the type of machine-learning algorithm to be used). For each selected machine-learning algorithm, the application may also select a set of one or more hyperparameters to be used when evaluating the machine-learning algorithm.

In step 350, each model is evaluated. Each model comprises at least one machine-learning algorithm and the set of required hyperparameters. It should be understood that two models may comprise the same machine-learning algorithm but with different sets of hyperparameters. K-fold cross-validation may be used. In k-fold cross-validation, the dataset is partitioned into k equally sized subsets, and then, over k iterations, a single subset is selected for testing the model, while the remaining k−1 subsets are used for training the model, such that, across all k iterations, each subset is used once for testing the model. The application may initiate a plurality of worker threads to evaluate a plurality of models in parallel. In addition, the application may generate an evaluation score (e.g., an accuracy score within a range from zero to one) for each model. During step 340, the application may also represent its progress (e.g., status, percentage complete, etc.) and/or provide statistics about the evaluation (e.g., number of worker threads used, CPU usage for each worker thread, memory usage for each worker thread, etc.) within the graphical user interface.

In step 360, the application provides a “leaderboard” of at least a topmost subset of the evaluated models in the graphical user interface. Specifically, the evaluated models may be listed in order of their respective evaluation scores, with the highest scoring model at the top and the lowest scoring model at the bottom. The list may comprise a description of the model (e.g., an identification of the machine-learning algorithm and the hyperparameters used for the model) and the evaluation score. In addition, the list may comprise other statistics for the model, such as the number of features used, the number of k-folds used, and/or the like. The list may also comprise inputs for selecting and/or exporting each model (e.g., for deployment on the user's prediction service).

In step 370, the application determines the model(s) to be used. For example, the user may select one or more models from the leaderboard using one or more associated inputs in the graphical user interface. The user may select a single model or may select a plurality of models (e.g., comprising an ensemble of machine-learning algorithms). Once at least one model is selected, the graphical user interface may enable one or more inputs for deploying the selected model(s) to the user's prediction service.

In step 380, the application deploys the selected model(s) to the user's prediction service (e.g., in response to the user's selection of a deployment input). The user's prediction service may be a cloud service that the user has registered with the user's account on platform 110. For example, the user may assign a role within the user's cloud service to server application 112, and, via one or more account setting screens of the graphical user interface, provide server application 112 with the credentials for accessing the user's cloud service according to the assigned role. Thus, server application 112 may access the user's cloud service to directly deploy the selected model(s) on the user's cloud service.

2.2. Time-Based Trial Selection

In an embodiment, selection module 113 facilitates faster model selection using time and/or accuracy estimate-based trial selection to optimize time and/or accuracy in parallel to provide intermediate results. In addition, the next model to be trialed may be selected based on the probability that it will be the most accurate among available models within a time frame that has been specified by the user. This probability may be computed as the a priori predictive accuracy estimate for the model, multiplied by the probability that the algorithm will be fully trained within the user-specified time frame.

Specifically, the optimization algorithm may select, for the next batch of models to be trialed, those candidates with the highest accuracy based on previous trials. Then, a train-time estimation algorithm selects the models with the fastest train times that fit the user-specified time frame from among these candidates. The selected models are then evaluated.

This time-based and accuracy-based model selection can reduce the time between the start of the evaluation process (e.g., represented by step 350 in process 300) and the presentation of at least an initial leaderboard (e.g., represented by step 360 in process 300) from which a user can select one or more models. Selection module 113 may also provide a continually updated view of the progress of the evaluation process.

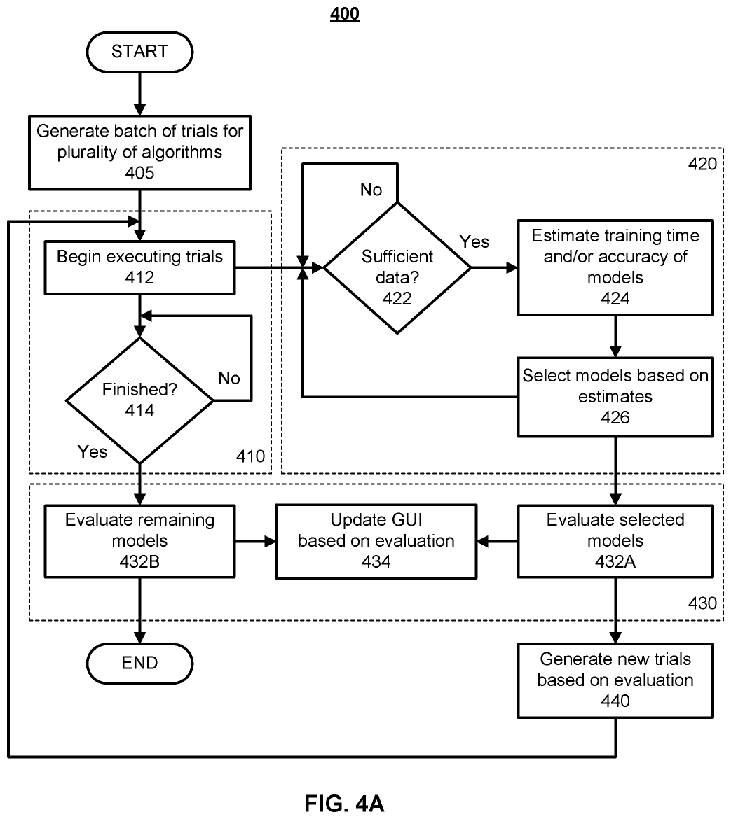

FIG. 4A is a block diagram that illustrates a process 400 for time-based and accuracy-based trial selection, according to an embodiment. While process 400 is illustrated with a certain arrangement and ordering of steps, process 400 may be implemented with fewer, more, or different steps and a different arrangement and/or ordering of steps. As will be apparent, process 400 may include at least portions of steps 340-360 of process 300. For example, step 405 may be part of step 340, steps 412, 414, 422, 424, 426, 432, and 400 may be part of step 350, and step 434 may be part of step 360.

Process 400 may be implemented by the disclosed application, and, in an embodiment, specifically by selection module 113 of server application 112. More specifically, steps 412 and 414 may be implemented by a trial-based optimization service 410 of selection module 113, steps 422, 424, and 426 may be implemented by an estimation service 420 of selection module 113, and steps 432 and 434 may be implemented by a model evaluation service 430 of selection module 113. The remaining steps may be implemented by services 410 and/or 430 or other services.

In step 405, selection module 113 generates a batch of trials for a plurality of machine-learning algorithms to be evaluated. In an embodiment, the plurality of machine-learning algorithms may be selected at random and/or in random order. In addition, selection module 113 may generate a random set of hyperparameters to be used with each of the machine-learning algorithms. For example, selection module 113 may generate a trial by selecting a machine-learning algorithm and a set of hyperparameters to be used in a trial with the selected machine-learning algorithm. It should be understood that selection module 113 may generate a plurality of trials for any given machine-learning algorithm by selecting different sets of hyperparameters.

In step 412, trial-based optimization service 410 begins executing the batched trials, which will initially consist of the trials generated in step 405. In an embodiment, a plurality of trials are executed in parallel, with callbacks to obtain internal states and/or statistics for each trial. For example, a plurality of worker threads may simultaneously execute trials. As the trials are executed, one or more statistics about each trial are obtained and stored, for example, in database(s) 114. These statistics may include, for example, the execution time of each trial, the state(s) of each trial, and/or the results of each trial.

In step 414, trial-based optimization service 410 determines whether or not the optimization process is finished. In an embodiment, trial-based optimization service 410 may continue generating and executing new trials until the service is stopped by a user (e.g., via an input of the graphical user interface). Alternatively or additionally, trial-based optimization service 410 may continue executing awaiting trials until all trials have been executed. If the optimization process is not finished (i.e., “No” in step 414), trial-based optimization service 410 selects and begins executing the next trial. Otherwise, if the optimization process is finished (i.e., “Yes” in step 414), process 400 proceeds to step 432B.

In step 422, train-time and/or accuracy estimation service 420 (or trial-based optimization service 410) determines whether or not there are sufficient data to perform an intermediate selection of models to be evaluated. The data in this case may comprise the trial statistics stored (e.g., in database(s) 114) by trial-based optimization service 410. In an embodiment, sufficient data may be determined to exist when a predetermined number of trials (e.g., one, two, five, ten, etc.) and/or models have been successfully executed. The threshold for determining whether or not sufficient data exists to perform an intermediate selection may be specified by a user or be a system-wide setting.

In step 424, estimation service 420 samples a batch of trials which have been completed, and estimates the time to train each model represented by each trial. In an alternative embodiment to the one illustrated in FIG. 4A, step 424 could be performed prior to step 422, for example, as models are trialed (e.g., for each pair of model and dataset that is trialed). In either case, estimation service 420 may estimate an approximate training time for each model based on a train-time model that is designed to predict run times for training a model based on the trial statistics accumulated by trial-based optimization service 410 (e.g., including the execution times of the trials) for that model. Specifically, the train-time model may comprise a black-box machine-learning regression algorithm for fit-time estimation that accounts for implementation details, hardware, and the influence of any third-party sources. In an embodiment, the train-time model performs uncertainty estimation (if possible), using, for example, Gaussian processes (GP), a relevance vector machine (RVM), and/or the like. The train-time estimation may be based on features from third-party datasets, comprising, for example, synthetic data, open source datasets, datasets uploaded by users, and/or the like.

In step 426, estimation service 420 selects one or more models with the fastest estimated training times. The training time for each model may be determined based on the execution times of the trial executed for that model. Estimation service 420 may select any models for which the estimated training time is below a predetermined threshold amount of time (e.g., a user-specified or system-wide threshold amount of time). Alternatively or additionally, estimation service 420 may select a predetermined number or percentage of models with the fastest estimated training times. In any case, the selected model(s) are provided to model evaluation service 430. Specifically, process 400 proceeds to step 432A. In this manner, slower models are initially filtered out from evaluation by model evaluation service 430 in order to provide faster results (e.g., in the leaderboard). However, it should be understood that eventually all models will be evaluated by model evaluation service 430.

In an embodiment, in step 426, estimation service 420 also selects the one or more models based on accuracy, in addition to their estimated training times. Specifically, estimation service 420 may select a subset of models with the highest estimated accuracy and an estimated training time within a predefined time frame (e.g., a user-specified time frame). For example, each model in the batch of sampled models may be ranked according to a score, and a subset of models with the highest score (e.g., one model with the highest score, three models having the three highest scores, etc.) may be selected for the next evaluation. The score for each model may comprise a product of the probability of the model having a training time within the predefined time frame multiplied by the estimated accuracy of the model. Advantageously, the selection of models based on both accuracy and training time appropriately manages the tradeoff between time and efficacy.

For the sake of illustration, a non-limiting example of an estimation service 420 that selects model(s) based on accuracy and training time will now be described. Model A may be estimated to take eight minutes to train with an estimated accuracy of R²=0.5, whereas Model B is estimated to take ten minutes to train with an estimated accuracy of R²=0.8. In this example, the standard deviation for the training times is assumed to be two minutes, and the standard deviation for the estimated accuracy is assumed to be 0.1. Assuming a predefined (e.g., user-specified) time frame of ten minutes, Model A will be assigned a score of 0.35 (i.e., R² of 0.5 multiplied by the 70% chance of the training time being within ten minutes), and Model B will be assigned a score of 0.4 (i.e., R² of 0.8 multiplied by the 50% chance of the training time being within ten minutes). In this case, estimation service 420 will select Model B over Model A, since it has the higher score, indicating that, on average, Model B will lead to better results within the predefined time frame than Model A, even though Model A takes less time to train.

In an embodiment, steps 422-426 may be performed iteratively, as new data is accumulated (e.g., in database(s) 114) by trial-based optimization service 410. In other words, after step 426, estimation service 420 may return to step 422 to check whether or not there is sufficient new data to estimate training times for another sample of models.

In step 432A, model evaluation service 430 evaluates the sample of model(s) selected by estimation service 420 in step 426. Specifically, model evaluation service 430 may compute an evaluation score for each of the model(s) based on the executed trial(s) for that model.

In step 434, model evaluation service 430 updates a graphical user interface based on the evaluated models. For example, model evaluation service 430 may generate or update a list of at least a subset of the evaluated models (e.g., identifying the machine-learning algorithm and hyperparameters), ranked from highest evaluation score (e.g., at the top) to the lowest evaluation score (e.g., at the bottom). In an embodiment, each model in the list is selectable and deployable by a user (e.g., to the user's prediction service). Advantageously, the graphical user interface may be updated with intermediate evaluation results for those models selected by estimation service 420, even before all trials have been executed by trial-based optimization service 410 and before all models have been evaluated by model evaluation service 430. Thus, a user can begin reviewing the evaluation results before completion of step 350 in process 300, and, in an embodiment, even select and deploy a model before completion of step 350.

In addition, model evaluation service 430 may update a progress indicator within the graphical user interface based on the evaluated models. The progress indicator may represent the cumulative amount or percentage of time that has passed since trial-based optimization service 410 began the optimization process and/or the amount or percentage of time remaining before trial-based optimization service 410 finishes the optimization process. Thus, the user can perceive how much time is required before the final leaderboard (e.g., listing a complete ranking of the most accurate models) is posted within the graphical user interface.

In step 440, selection module 113 generates zero or more new trials based on the evaluation of models by model evaluation service 430 in step 432A. Selection module 113 adds any newly generated trials to the batch for trial-based optimization service 410. These new trials will eventually be executed by trial-based optimization service 410 in step 412.

In step 432B, once trial-based optimization service 410 has completed executing all trials (e.g., once the batch of trials is empty or the user stops the process), model evaluation service 430 evaluates any remaining models. Model evaluation service 430 then performs a final update to the graphical user interface in step 434, to reflect any final evaluations, and process 400 ends.

Eventually, the best performing models, regardless of estimated training times, will appear at the top of the leaderboard of evaluation results (e.g., in the final results or later intermediate results). That is to say, process 400 will not get stuck evaluating only the fastest models. However, models, which are estimated to have faster training times, will show up first in the intermediate evaluation results, whereas models, which are estimated to have slower training times, will show up later in the intermediate or final evaluation results. In this manner, evaluation results for at least some models can be posted faster, while still enabling the optimal model to be selected in the end. In addition, the user can iteratively track the progress of the evaluation results as they are posted and/or updated.

FIG. 4B is a block diagram that illustrates an example data flow within process 400, according to an embodiment. As illustrated, model evaluation service 430 receives data 450. Model evaluation service 430 may utilize this data to select machine-learning algorithms, and provide the selected machine-learning algorithms to trial-based optimization service 410.

Trial-based optimization service 410 receives the selected machine-learning algorithms from model evaluation service 430, receives configuration information 455, and generates a batch of trials 460 based on the selected machining-learning algorithms and configuration information 455. Trial-based optimization service 410 begins executing the batch of trials and provides the results as a batch of models 460 to train-time and/or accuracy estimation service 420 as they become available.

Estimation service 420 receives the batch of models 460 from trial-based optimization service 410, and selects a subset of the batch of models 460, having the fastest estimated train times, to produce a set of sampled models 465. Estimation service 420 provides the sampled models 465 to model evaluation service 430 for evaluation. In an embodiment, one or more models may be randomly selected and added to the set of sampled models 465 for evaluation, in order to prevent local minima. This provides a tradeoff between exploration and exploitation. The amount (e.g., number or percentage) of random models to be included in the sampled models 465 may be defined by the user and/or the system.

Model evaluation service 430 receives the sampled models 465 from estimation service 420, and evaluates each of the sampled models 465. Model evaluation service 430 updates a leaderboard and/or progress indicator 470 within a graphical user interface based on the evaluation results. In addition, model evaluation service 430 may select additional machine-learning algorithms and/or hyperparameters (e.g., based on the evaluation results), and provide those additional models to trial-based optimization service 410 to generate new trials. In an embodiment, this loop may continue until stopped by a user.

2.3. Train-Time and Accuracy Estimation

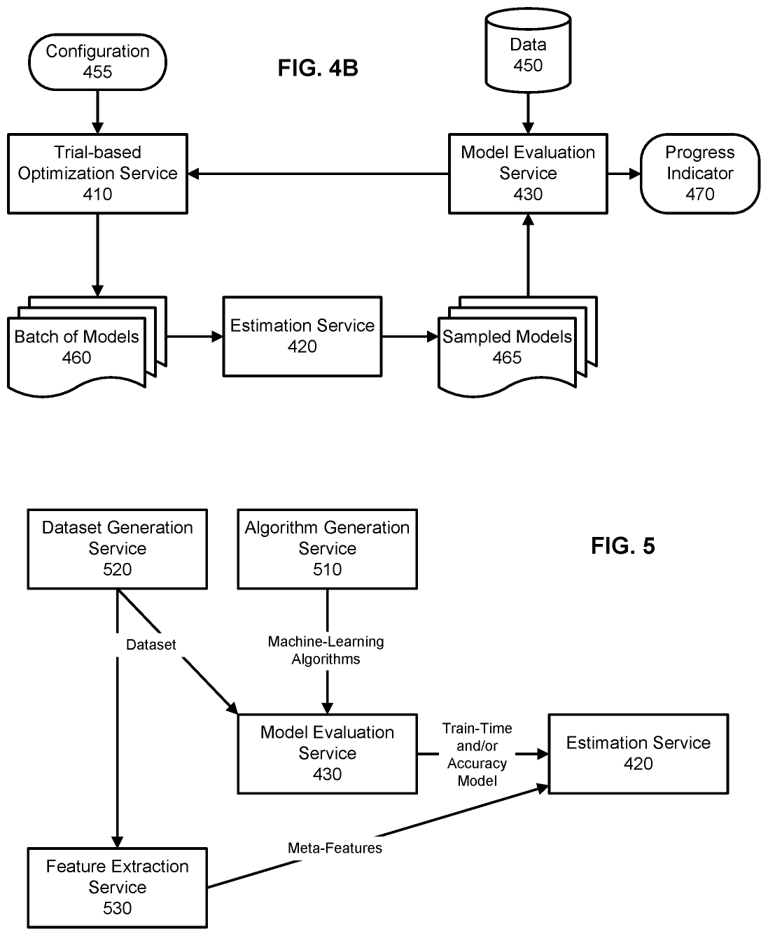

FIG. 5 is a block diagram that illustrates an example data flow for configuring train-time estimation and/or accuracy estimation (e.g., which estimates accuracy by evaluating the trial) service 420, according to an embodiment. Notably, algorithm generation service 510, dataset generation service 520, and/or feature extraction service 530 may be implemented by selection module 113 of server application 112.

Initially, algorithm generation service 510 generates or selects one or more machine-learning algorithms and provides those algorithm(s) to model evaluation service 430, to be evaluated for use as the train-time model and/or accuracy model used by estimation service 420. In addition, dataset generation service 520 generates a dataset and provides the generated dataset to model evaluation service 430, to be used in evaluating the machine-learning algorithms from algorithm generation service 510.

In addition, dataset generation service 520 provides the generated dataset to feature extraction service 530. Feature extraction service 530 extracts meta-features from the dataset, and provides those meta-features to estimation service 420.

Model evaluation service 430 evaluates the machine-learning algorithms, and selects the machine-learning algorithm(s) and hyperparameters to be used as the train-time and/or accuracy model. For example, model evaluation service 430 may select a model with the highest evaluation score (e.g., representing the highest accuracy). Model evaluation service 430 provides the selected train-time and/or accuracy model to estimation service 420. Estimation service 420 may then use the train-time and/or accuracy model and meta-features to predict the training times and/or accuracy for models in the future, for example, as trials for those models are executed by trial-based optimization service 410.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
select a plurality of machine-learning algorithms;
generate a batch of trials from the plurality of machine-learning algorithms;
begin executing at least a portion of the batch of trials; and,
during execution of the batch of trials, provide intermediate evaluation results by, in each of one or more iterations,
estimating a training time and model accuracy for two or more of models represented in the batch of trials,
selecting at least one of the two or more models with a highest estimated model accuracy and an estimated training time within a predefined training time,
evaluating the at least one model before evaluating any other ones of the two or more models, and
updating a graphical user interface to provide the evaluation results for the subset of models.

2. The method of claim 1, further comprising using the at least one hardware processor to, during execution of the batch of trials, in each of the one or more iterations, update a progress indicator in the graphical user interface.

3. The method of claim 1, wherein selecting the plurality of machine-learning algorithms comprises randomly selecting a plurality of machine-learning algorithms from a database of available machine-learning algorithms.

4. The method of claim 3, wherein each model comprises a machine-learning algorithm and one or more hyperparameters, and wherein generating the batch of trials comprises determining at least one set of one or more hyperparameters to be used for each of the plurality of machine-learning algorithms.

5. The method of claim 4, wherein generating the batch of trials comprises determining a plurality of sets of one or more hyperparameters to be used for each of the plurality of machine-learning algorithms.

6. The method of claim 3, wherein the plurality of machine-learning algorithms comprise one or more of a logistic regression algorithm, a linear regression algorithm, a polynomial regression algorithm, a k-nearest neighbor algorithm, a random forest algorithm, a deep-learning algorithm, or a deep neural network.

7. The method of claim 1, wherein the plurality of machine-learning algorithms are selected based on one or more user-specified parameters, wherein the user-specified parameters comprise one of a plurality of types of machine-learning algorithm, and wherein the plurality of types of machine-learning algorithms comprise regression and classification.

8. The method of claim 1, wherein, during execution of the batch of trials, a plurality of trials within the batch of trials are executed in parallel.

9. The method of claim 1, further comprising using the at least one hardware processor to, during execution of the batch of trials, store statistics for each trial being executed, wherein the training time for the two or more models is estimated based on the stored statistics for the trials representing the two or more models.

10. The method of claim 9, wherein each of the one or more iterations is begun when an amount of the stored statistics reaches a threshold that represents sufficient data to select the two or more models.

11. The method of claim 9, wherein estimating the training time for two or more of the plurality of models comprises using a train-time model, comprising a regression algorithm, to predict the training time for each of the two or more models based on the stored statistics.

12. The method of claim 11, further comprising using the at least one hardware processor to:
generate the train-time model by evaluating a plurality of available machine-learning algorithms using a generated dataset; and
select one or more of the plurality of available machine-learning algorithms to be used in the train-time model.

13. The method of claim 1, wherein the one or more iterations comprise a plurality of iterations.

14. The method of claim 1, further comprising using the at least one hardware processor to, during execution of the batch of trials, in each of the one or more iterations, after evaluating the at least one model:
generate one or more new trials; and
add the one or more new trials to the batch of trials being executed.

15. The method of claim 14, further comprising using the at least one hardware processor to execute the batch of trials and add new trials to the batch of trials being executed until stopped by a user operation.

16. A system comprising:
at least one hardware processor; and
one or more software modules configured to, when executed by the at least one hardware processor,
select a plurality of machine-learning algorithms,
generate a batch of trials from the plurality of machine-learning algorithms,
begin executing at least a portion of the batch of trials, and,
during execution of the batch of trials, provide intermediate evaluation results by, in each of one or more iterations,
estimating a training time and model accuracy for two or more of models represented in the batch of trials,
selecting at least one of the two or more models with a highest estimated model accuracy and an estimated training time within a predefined training time,
evaluating the at least one model before evaluating any other ones of the two or more models, and
updating a graphical user interface to provide the evaluation results for the subset of models.

17. A non-transitory computer-readable medium having instructions stored therein, wherein the instructions, when executed by a processor, cause the processor to:
select a plurality of machine-learning algorithms;
generate a batch of trials from the plurality of machine-learning algorithms;
begin executing at least a portion of the batch of trials; and,
during execution of the batch of trials, provide intermediate evaluation results by, in each of one or more iterations,
estimating a training time and model accuracy for two or more of models represented in the batch of trials,
selecting at least one of the two or more models with a highest estimated model accuracy and an estimated training time within a predefined training time,
evaluating the at least one model before evaluating any other ones of the two or more models, and
updating a graphical user interface to provide the evaluation results for the subset of models.
